(19) United States
(12) Patent Application Publication
(10) Pub. No.: US 2019/0180205 A1
(43) Pub. Date: Jun. 13, 2019

(54) INTERACTIVE LOCATION PLAN OVERLAY SYSTEM

(71) Applicant: Common Areas, LLC, Tustin, CA (US)

(72) Inventors: Joseph Casey Rue, Tustin, CA (US); Aaron Seabaugh, Tustin, CA (US)

(21) Appl. No.: 15/839,627

(22) Filed: Dec. 12, 2017

(51) Int. Cl. G06Q 10/06; G06F 3/0484; G01C 21/00; G06Q 10/10

(52) U.S. Cl. CPC G06Q 10/0631; G06F 3/04845; G06Q 10/103; G01C 21/005; G06Q 10/0633

(57) ABSTRACT

An interactive location plan overlay system has a location interface to one or more maps for a location, and an overlay interface to one or more location plan overlays each associated with a specific one the maps. A mapping user interface is in communication with the location interface and the overlay interface to generate a display of a given one of the maps and the location plan overlays associated therewith in alignment with each other. An action item interface is receptive to input of an action item, and associated with a specific location on a selected one of the location plan overlays of the corresponding one of the maps. An action engine in communication with the action item interface. The received action item is stored and assignable by the action engine to a contact account for resolution.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates to information systems for collaborative property and facilities management, and more particularly, to an interactive location plan overlay system.

### 2. Related Art

The management and maintenance of commercial property and other facilities span a wide range of functions involving a variety of professionals. A typical facility may have heating/ventilation/air conditioning (HVAC) systems to provide a comfortable environment for occupants, as well as electrical systems for powering such HVAC systems as well as for lighting and powering office/computer equipment. There may also be plumbing systems that provide running water to, and drainage from, the facility. Additionally, there may be safety systems such as smoke alarms, fire sprinklers, and the like, along with as security systems that monitor and control access to the facility. These systems require regular maintenance and repairs, and while some of the routine work may be performed by on-site staff who are hired by a property owner or facility manager, due to the complexity of the systems, the more specialized and/or technical tasks require outside contractors.

In addition to the maintenance and repair work for the aforementioned systems, the interior structure of a building is repaired and upgraded from time to time, which require professionals such as interior decorators, painters, carpenters, and the like. The exterior of the building, along with its surrounding landscaping, likewise require maintenance and upkeep, which involves another set of professionals such as landscapers and landscape architects. For both the exterior and the interior, cleaning and waste collection and disposal services may be hired.

With various occupants moving into and out of different spaces, and churn with ongoing occupants, property and/or facility managers (also referred to generally as managers) may assist with planning and managing space allocations. During this process, upgrades or changes to the foregoing infrastructure systems may be requested or necessary, and so the manager may lead and direct such efforts being performed by staff and outside contractors. Different information technologies are used to manage certain aspects or subparts of this process by the property and facility maintenance/management industry, including financial and accounting systems, building management systems, and work order systems.

For instance, a maintenance or management help desk or the like may receive phone calls or e-mails regarding a maintenance issue at a particular location in the facility. The location, along with the issue to be addressed, may be recorded and subsequently assigned to staff member to resolve. To the extent the issue is immediately identified as one requiring the assistance of an outside professional, or upon further inspection it is determined that such assistance is necessary, the manager may initiate contact with the service provider. The task may be tracked with in a work order system, but entry of the task, along with initiating the work order itself may be done manually by the manager. The manager may take the service provider in-person to the location and remain there until completion. Once the work is completed, the task may be marked complete, followed by payment to the service provider. The processing of the payment may be via a separate accounting system, the data for which is manually entered by the manager from an invoice generated by the service provider.

As illustrated, the regular process necessary to address maintenance and other issues arising in a facility involves much manual coordination by a manager, which may be one or more individuals with different areas of responsibility. For instance, one manager may handle all maintenance tasks associated with the HVAC and electrical systems, while another handles all landscaping, and so on. Where the facility is sufficiently small, all of the issues arising in relation to any of the different aspects may be handled by a single individual.

Yet, because there are numerous, dissimilar tasks that may be, at times, difficulty coordinate, there is a need in the art for technical tools incorporating work requests, workflow, location-based services, map integration, floor plan overlays, and network contact collaboration. There is a need for streamlining processes, increasing visibility of work being performed for a facility, and setting foundations from which additional technologies for improving facility management can be built.

### BRIEF SUMMARY

The present disclosure is directed to an interactive location plan overlay system that streamlines and increase visibility of work being performed at some physical location. The present disclosure may refer to such location as a facility, which may include residential buildings, commercial buildings, agricultural lands, farms, parks, golf courses, parking lots and structures, railroad tracks, airports, natural landscapes and trails, cemeteries reservoirs, landmarks, and so on. Additionally, the present disclosure may refer to a location within movable objects such as boats, automobiles, motor homes, mobile homes, equipment, and the like. The contemplated system is understood to be configurable to be utilized in connection with any structure, location, or object in which plans can be drawn and overlaid in order to denote the physical location. Various embodiments contemplate the integration of interactive location diagrams, map overlays, request and issue management, and contact networking.

One embodiment of the system may include a location interface to one or more maps for a location. Each of the maps may correspond to a level and may also be defined by a common coordinates grid. There may also be an overlay interface to one or more location plan overlays. Each of the location plan overlays may be associated with a specific one of the maps. The location plan overlays may also be defined by the common coordinates grid and pertain to a category of the location. The system may further include a mapping user interface that is in communication with the location interface and the overlay interface to generate a display of a given one of the maps and the location plan overlays associated therewith in alignment with each other based upon the common coordinates grid. There may be an interface that is receptive to input of an action item, a task, reported issue or other work information collection. The action item or other work related data may be associated with a specific location on a selected one of the location plan overlays of the corresponding one of the maps. The specific location of the action item may be being defined in accordance with the common coordinates grid. The system may also include an action engine in communication with the action item interface. The received action item may be stored and assignable by the action engine to a contact account for resolution.

Another embodiment of the present disclosure is directed to a method for graphical collaboration of managing a location. The method may include a step of retrieving a map of the location from a location database by an interactive location plan overlay computer system. The map may correspond to a level and may be defined by a common coordinates grid. There may also be a step of retrieving a location plan overlay in response to a selection thereof by an interactive location plan overlay computer system. The location plan overlay may be defined by the common coordinates grid, associated with the level, and pertain to a category of the location. The method may also include transmitting the map and the location plan overlay to a first computer system for displaying on a first user interface for a first user. The location plan overlay and the map may be in alignment with each other based upon the common coordinates grid. There may also be a step of receiving an input of a specific location in the location plan overlay from the first user interface. The specific location may be defined by a set of selection coordinates. The method may further include storing, by the interactive location plan overlay computer system, the set of selection coordinates in association with item data received from the first user interface as an action item. The method may further include transmitting to the first computer system for displaying, on the first user interface, a graphical representation of the stored action item at the location within the location plan overlay and the map as defined by the set of selection coordinates.

According to another embodiment, the present disclosure contemplates a method for graphical collaboration of managing a location. The method may include transmitting a request for a map of the location to an interactive location plan overlay computer system. The map may correspond to a level and defined by a common coordinates grid. There may be a step of receiving a selection of a location plan overlay from a user interface. There may also be a step of transmitting a request for the selected location plan overlay to the interactive location plan overlay computer system. The location plan overlay may be defined by the common coordinates grid, associated with the level, and pertain to a category of the location. The method may also include receiving the map and the selected location plan overlay from the location plan overlay computer system. There may be a step of displaying, on a user interface, the received map and the location plan overlay in alignment with each other based upon the common coordinates grid. The method may include receiving, from the user interface, an input of a specific location in the location plan overlay defined by a set of selection coordinates. There may also be a step of transmitting the set of selection coordinates to the interactive location plan overlay computer system. The selection coordinates may be transmitted in association with item data received from the user interface as an action item. The method may also include displaying, on the user interface, a graphical representation of the action item at the location within the location plan overlay and the map as defined by the set of selection coordinates.

Certain other embodiments of the present disclosure contemplate respective computer-readable program storage media that each tangibly embodies one or more programs of instructions executable by a data processing device to perform the foregoing methods. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram showing an interactive location plan overlay system and an exemplary environment in which such system may be implemented;

FIG. 2 is a block diagram illustrating the components of an example embodiment of the location plan overlay system;

FIG. 3 is a screen shot of an exemplary user interface of the interactive location plan overlay system;

FIGS. 4A-4D are flowcharts showing the sequence of interaction steps for different categories of users of the system;

FIG. 5 is a data model diagram illustrating the exemplary tables, fields, and inter-relationships between tables that may be used to implement one embodiment of the interactive location plan overlay system;

FIG. 6 is a diagram showing the various logical components of an exemplary implementation of the interactive location plan overlay system;

FIGS. 7A and 7B are screen shots of another exemplary user interface of the interactive location plan overlay system;

FIG. 8 is a flowchart illustrating a sequence of steps the system takes to present a default view;

FIG. 9 is a flowchart illustrating a sequence of steps involved in presenting pins corresponding to action items upon the user selecting a location on a map;

FIG. 10 is a flowchart illustrating a sequence of steps involved in selecting a level/floor for display;

FIG. 11 is a flowchart illustrating a sequence of steps involved in selecting an overlay plan for display;

FIG. 12 is a flowchart illustrating a sequence of steps involved in selecting an action item from a location;

FIG. 13 is a flowchart illustrating a sequence of steps involved in creating an action item from a selected floor and plan overlay;

FIG. 14 is a screen shot of the user interface of the interactive location plan overlay system with an action item viewing window;

FIG. 15 is a screen shot of the user interface with pin/marker interaction features being depicted;

FIG. 16 is a screen shot of the user interface with an issue reporting dialog presented;

FIG. 17 is a screen shot of an administrative user interface for adding location levels and plan overlays; and

FIG. 18 is a screen shot of a primary workspace of the user interface showing a graphical representation of the plan overlay.

### DETAILED DESCRIPTION

The detailed description set forth below in connection with the appended drawings is intended as a description of the presently preferred embodiment of the interactive location plan overlay system, and is not intended to represent the only form in which the present disclosure may be developed or utilized. The description sets forth the functions and the sequence of steps for the development and operation of the illustrated embodiment. It is to be understood, however, that the same or equivalent functions and sequences may be accomplished by different embodiments that are also intended to be encompassed within the scope of the present disclosure. It is further understood that the use of relational terms such as first, second, and the like are used solely to distinguish one from another entity without necessarily requiring or implying any actual such relationship or order between such entities.

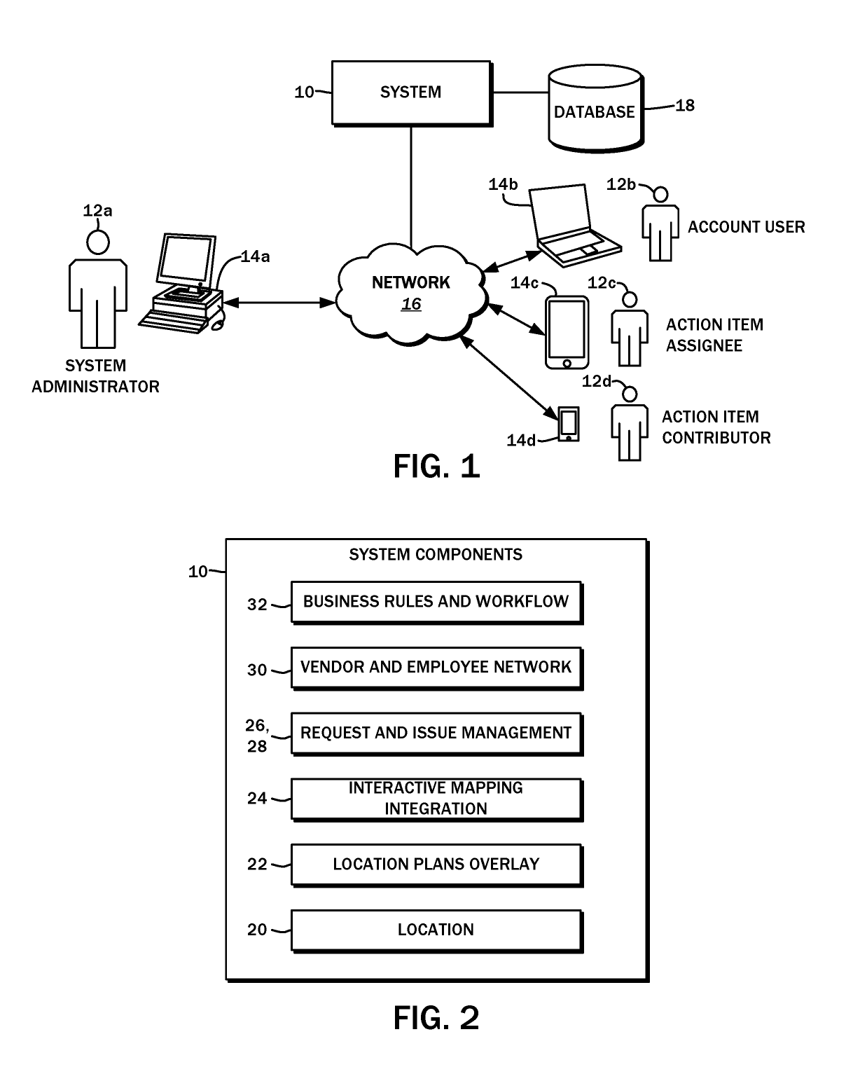

Referring to the block diagram of FIG. 1, one embodiment of an interactive location plan overlay system 10 is shown in the context of an exemplary computing environment including multiple users 12a-12d each operating respective client computing devices 14a-14d that communicate with the interactive location plan overlay system 10 via a network 16. The system 10 is envisioned to incorporate interactive location maps and overlay diagrams with features directed to managing requests and issues that arise in relation to a building or other facility, along with integrated contact management for assigning work to different professionals. Additionally, as also discussed above, these requests and issues may pertain to physical objects, as well as virtual locations or logically defined locations in software, games, documents and other collections of information. As will be described in further detail below, the system 10 contemplates users interacting with location overlays such as building plans, site plans, landscape plans, floor plans, and the like, create work requests or report issues associated with each plan and/or building floor, and assign work to a network of users or contacts that are related to the request or reported issue. However, it is understood that reference thereto is not intended to limit the contemplated system 10 to those embodiments, and other contexts such as those described above may be readily substituted without departing from the scope of the present disclosure. Additionally, collaboration among multiple users is contemplated based upon workflow guidance and the application of business rules.

It is therefore contemplated that multiple users will interact with the system 10. To this end, four types of users 12 are envisioned: an administrative user, a general user that manages the data entry and work assignment process, a general user that is part of the network of individuals or entities that are assigned the work, and a general user that performs the work and otherwise contributes additional information to the system 10 to ensure continued progress, without being explicitly assigned the work via the system 10. By way of example, the first user 12a may be an administrator and therefore granted additional privileges permitting the modification of various features and configuration options of the system 10. The second, third, and fourth users 12b-d, although they may be categorized differently, may each be assigned a regular user account with limited access privileges.

The system 10 may be implemented on a server computer system that includes one or more processors, memory, and other data storage devices, and may be programmed with a series of instructions that are executed by the processor (and stored in the memory) to implement the methods of the present disclosure. Additionally, the server computer system may include networking components, both hardware and software, that transmits to and receives data from remote computing nodes via the network 16. As will be described in further detail below, the software instructions executed by the system 10 may be defined as various interfaces, modules, and processing engines thereof. It will be appreciated by those having ordinary skill in the art that any suitable hardware or software combination may be used to implement the system 10, and the specifics presented herein are by way of example only and not of limitation.

The data utilized by the system 10 may be stored in a database 18, which is understood to encompass both the database management system (DBMS) as well as the data storage. The database 18 may be implemented as a separate component to the system 10, or as an integrated part thereof.

In order to receive and respond to requests from remote nodes, the system 10 may include a server application, one common implementation being a web (HTTP) server or other virtualized/hosted technologies. The additional functionality of the aforementioned interfaces, modules, and processing engines may be built on the platform of the web server. In a preferred, though optional embodiment, the use of the web server as the modality to exchange data with the client computing devices 14 is understood to allow for cross-platform compatibility and consistent rendering of the user interface across any and all computing or computer devices, as generally defined below.

Like the system 10, the various client computing devices 14a-14d of the users 12a-12d are understood to incorporate processors, memory, data storage, and networked communications modalities. In the illustrated example, the first client computing device 14a of the first user 12a may be a desktop computer system that includes, among other software programs, a web browser application that interacts with the web server of the system 10. Similarly, the second client computing device 14b may be a laptop computer that is functionally the same as the desktop computer system of the first client computing device, but mobile. Typically, with desktop-class operating systems, a keyboard and pointing device are used to interact with a windowing interface; certain embodiments of the present disclosure therefore describe user interactions consistent with this user interface, such as “clicking” or “scrolling” with a mouse, inputting keystrokes, and the like.

The third client computing device 14c is depicted as a tablet, which is understood to utilize a mobile operating platform such as iOS from Apple, Inc. or Android developed by Google or other device OS brands. Along these lines, the fourth client device 14d may be a smart phone that likewise utilizes a mobile operating platform like iOS, Android, etc., though having a smaller form factor compared to a tablet. Such mobile operating platforms can utilize various applications or “apps,” and while a web browser app installed on the device can be used to interact with the web browser of the system 10, the native app can implement a similar user interface as the cross-platform compatible web-based version and exchange data with the system 10. The communications protocol utilized by the native app may also be the hypertext transfer protocol as would be the case for the browser-implemented version. User interaction with tablets are typically through haptic inputs, as such devices are commonly equipped with touch displays. Any reference to interactions possible through other input modalities are understood to have equivalent or corresponding interactions or gestures in the touch input context such as “tapping,” “dragging,” “pinching,” and so on, and are intended to be applicable to the third and fourth client computing devices 14c, 14d.

Referring now to the block diagram of FIG. 2, additional details regarding the components of the interactive location plan overlay system 10 will be considered. According to one embodiment, there is a location interface 20 that accesses one or more maps for a facility location. As introduced above, one aspect of the system 10 contemplates incorporating interactive location maps and overlay diagrams; as referenced herein, the map may be of a particular location under management of the system 10. The location may refer to a building, along with the area within the property boundaries thereof. The map may also show the locale surrounding the property boundaries, and when set at a suitable zoom level, may show other buildings and property that is also under management of the system 10. Furthermore, a single building may include multiple floors or levels, and so there are understood to be maps corresponding to each. The maps are understood to be interactive in that, within a predefined window, the area within view can be panned or rotated, and the magnification may be increased or decreased. The interface to the map responds in real time to such map navigation commands, and adjusts the view accordingly.

The system also includes an overlay interface 22 to one or more location plan overlays. Each location plan overlay is associated with a specific one of the maps. Both the maps and the overlays are defined by a common coordinate grid by which a given overlay can be rendered in alignment with the map. By way of example, an overlay may be a building plan, a site plan, a landscape plan, floor plan, an HVAC system plan, an electrical plan, a plumbing plan, a lighting plan, or any other document that graphically illustrates some aspect of the building or facility accurately positioned along the coordinate grid, as well as in alignment with the underlying map. This integration of the maps, including the various levels/floors and the overlays associated thereto, is performed by a mapping user interface 24, which cooperate with the aforementioned location interface 20 and the overlay interface 22.

As indicated above, the system 10 also manages requests and issues that arises in relation to the facility, and thus includes an action item interface 26 therefor. In further detail, the action item interface is receptive to an input of an action item that is associated with a specific location on a selected one of the location plan overlays for a map. The location is defined in accordance with the common coordinate grid mentioned earlier. Any problems that need to be addressed by the facility management staff may be tagged by location, and a graphical representation of the action item is shown specifically where the issue has been identified or the request for work was made. Other aspects of the request and issue management such as linking the action item with specific service providers and/or employees, or assigning the action items to a specific account, may be handled by an action engine 28 that is in communication with the action item interface 26. The listing of available contact accounts, e.g., those which are associated with service providers as well as employees and other users, which are to be selected by the user assigning the action item, may be provided by an action item assignment interface 30. Further workflow procedures on how an action item is handled by be defined by a business rules engine 32.

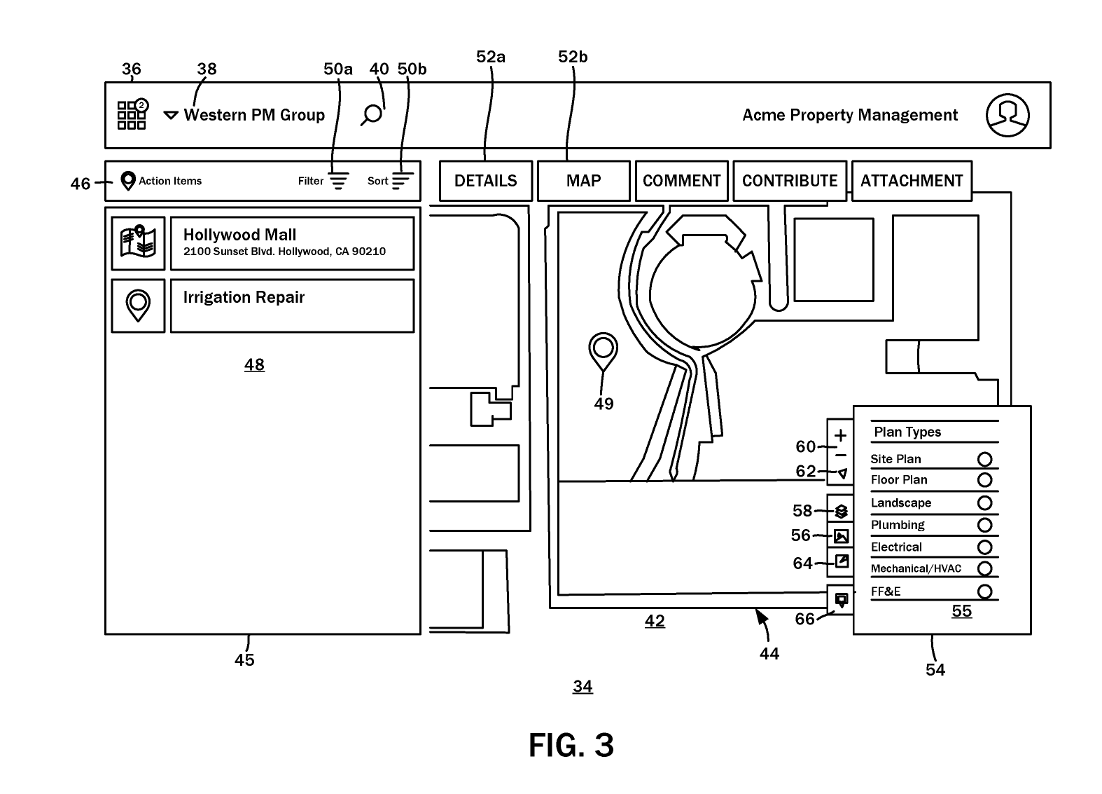

FIG. 3 shows an exemplary graphical user interface 34 of the system 10, which aggregates and arranges activatable interface elements and presents the data managed by the system 10. A top header section 36 includes a property group selection dropdown list 38. It is expressly contemplated that a given user or administrator account may be associated with more than one collection of properties. That is, a single property management company may handle different groups of properties for multiple clients. To the extent the currently logged in user account is associated with more than one property group, the property group selection dropdown list 38 may show those other property groups, and upon activation, allow the selection thereof. After so selecting a different property group, the entirety of the graphical user interface 34 may be refreshed with data pertaining thereto. The top header section 36 also includes a search input field 40.

The graphical user interface 34 includes a primary workspace 42 in which a map 44 is rendered. As discussed above, the map 44 is rendered dynamically, and the interface is receptive to panning, zooming, and rotating command inputs that accordingly adjust the view of the same. Displayed in the left portion of the interface is an left sidebar 45, which is further divided into a menu bar 46, and an action item listing 48 that may show each of the action items associated with a particular location or a property group. The menu bar 46 includes a filter button 50a and a sort button 50b that filters the action item listing 48 according to specified filtering criteria, and sorts the action item listing 48 according to a specified sorting criteria, respectively. Those having ordinary skill in the art will readily recognize the modality by which such sorting and filtering functions may be implemented, so the details thereof are omitted.

Each of the action items or other work related data in the listing 48 may correspond to a marker or pin 49 that is placed on the map 44. The action item is understood to be either a request to perform some work, or an issue that requires further attention. The pin 49 is placed at the specific location within the map 44 at which this issue or request pertains.

Overlaid on top of the map 44 and positioned near the upper portion of the primary workspace 42 are a set of activatable buttons 52a-52e that invoke additional functionality of the graphical user interface 34. These include a first button 52a for viewing additional details of a selected action item, and a second button 52b for selecting different maps.

Overlaid on top of the map 44 and position near the lower right corner of the primary workspace 42 is an interface window 54 that selectively presents various interfaces in which additional functionality may be invoked. In the illustrated example of FIG. 3, there is a map selection interface 55 rendered therein. From this interface, it is possible to select one or more of the overlays to display on the map 44. By way of example, there is a site plan, a floor plan, a landscape plan, a plumbing plan, an electrical plan, a mechanical/HVAC (heating, ventilation, air conditioning) plan, and an FF&E (furniture, fixtures, and equipment) plan. These plans are understood to contain the respective elements of each type of overlay, positioned at points within the map where they are actually located. This map selection interface 55 may be invoked by activating a map selection tab 56. Alternatively, there may be a level selection interface that presents a listing of the levels or floors of the facility, with the selection thereof resulting in that level being rendered as the map 44 in the primary workspace 42. This interface may be invoked by activating a level selection tab 58.

A given plan may also include assets such as equipment, fixtures, and objects, as well as tangible or intangible attributes. In other embodiments besides those contemplated for property management such as vehicle maintenance (automobiles, aircraft, ships, etc.) these overlays may be for specific systems, such as electrical systems, hydraulic systems, engine and motive systems, and so on. These assets may be organized assigned various categories and subcategories, which can be related to equipment lists. For example, a water pump may be assigned a “plumbing” category, while a duct may be assigned a “HVAC” category. A list of assets for “plumbing” and “HVAC” can thus be generated based on the assigned categories.

Assets, as well as users, may be shown on the map 44 and/or any overlays. Some assets may be movable, so there may be a geolocation tracking unit that is attached to the asset and reports its location to the system 10. Coordinates of the position may be derived from the GPS receivers on the mobile devices associated with the users, and similarly reported to the system 10. With this information, it is possible to provide real time or at least regularly updated location information via the contemplated interface.

The interface window 54 may also include a zoom in/zoom out button 60, along with a location centering button 62 that detects the actual location of the client computing device 14, and centers the rendering of the map 44 based upon that location. Additionally, below the map selection tab 56 is a sharing button 64 that invokes an additional interface via which the rendered map can be shared to other destinations such as e-mail and so forth.

The foregoing elements of the graphical user interface 34 are presented for exemplary purposes only. Thus, additional features may be incorporated, or some of the features presented may be removed from alternative embodiments.

As indicated above, there are several roles a user or users 12 may perform in using the system 10, including acting as a creator of an action item or work related data, acting as an assignee of or a member of a group being assigned to, or contributing to, an action item, and acting as an administrator of the system 10. When acting as a creator of an action item, the graphical user interface 34 allows the user to navigate through different floors as well as overlay types, create new action items as pertaining to a specific floor/level and/or an overlay, and add pins to a specific action item that relates to a specific floor/level and/or an overlay. Additionally, descriptors, images, and other attachments may be associated or otherwise linked to the pin, and an indication of whether the pin has been checked or not may be set. When acting as an assignee of, or contributing to, and action item, the graphical user interface 34 allows the user to view the details of an action item on the map 44, navigate through floor plans that are associated to a pin, read the description of the pin, view the images attached to the pin, indicate if the pin is checked, and add additional pins to the map 44 along with associated description and images. When acting as an administrator, the graphical user interface 34 allows the user to manage floors/levels for a location, upload and manage overlays for a particular floor/level, and rotate and resize overlays to position on the map 44.

In addition to assigning action items to specific users 12, it is also possible for an action item to be assigned to a specific asset. As indicated above, an overlay may include one or more assets that represent various equipment, fixtures, objects, and the like such as HVAC units and pool pumps, for example. Thus, an action item indicating the need for repairing, replacing, etc. a component in the associated asset may also be assigned specifically thereto.

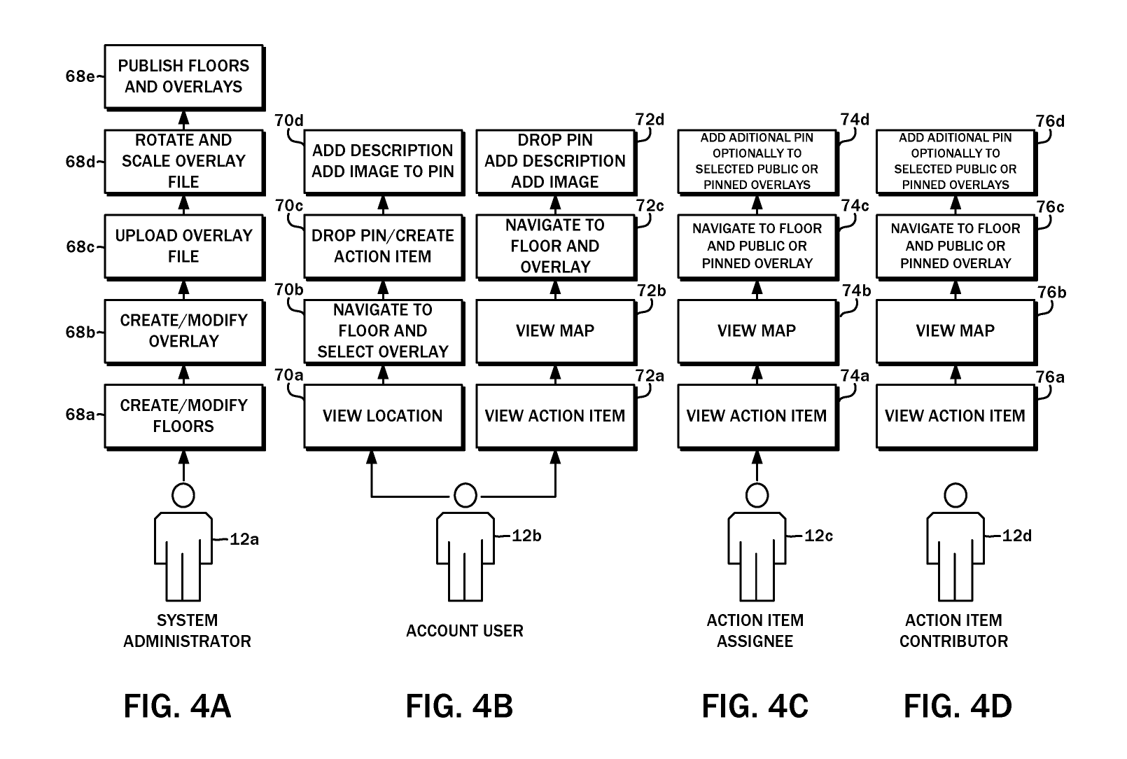

Referring now to the block diagram of FIG. 1 as well as the flowcharts of FIGS. 4A-4D, it is contemplated different users 12a-12d may proceed along various interaction sequences with the graphical user interface 34. These sequences are exemplary only, and it is understood that the user 12 may follow any desirable sequence during use. In other words, no guided process with strict enforcement of each step in the order depicted is required.

FIG. 4A depicts an example interaction of a system administrator or first user 12a, which begins with a step 68a of creating and/or modifying floors or levels of a building. For at least one of the floors, for some of the floors, or for each of the floors, the first user 12a may additionally create overlays in a step 68b. The overlay file may then be uploaded to the system 10 from the first client computing device 14a in a step 68c. The uploaded overlay may then be modified, that is, rotated and scaled for positioning on the map 44 in a step 68d. Upon completion of the positioning step, the map 44 of the floors/levels, together with each of the overlays associated thereto, may be published in a step 68e.

FIG. 4B depicts an example interaction of a regular account user 12b. There are two possible sequences contemplated, with a first sequence of steps 70a-70d, and a second sequence of steps 72a-72d. The first sequence begins with a step 70a of viewing the location from the graphical user interface 34. Then, in a step 70b, the user 12b navigates to a specific floor or level and selects an overlay. Thereafter, in a step 70c, a pin 49 can be dropped on a location within the overlay, which results in the creation of an action item. In a step 70d, a description and an image may be added to the action item. The second sequence 72 starts with viewing an action item in a step 72a, and then the map 44 is viewed according to a step 72b. The user navigates to a specific floor and overlay in a step 72c, then a pin 49 is dropped according to step 72d, along with the addition of the description and/or images.

FIG. 4C depicts an example interaction of a third user 12c that has been assigned an action item. The sequence begins with a step 74a of the user viewing the action item. That action item may also be viewed on the map 44 according to a step 74b. The user then navigates to a specific floor, then selects a public or pinned overlay in a step 74c. Additional pins may then be added to the selected public or pinned overlays per step 74d. The last step 74d is understood to be optional.

A similar sequence is contemplated for a contributor to an action item, or the fourth user 12d. This sequence is shown in the flowchart of FIG. 4D, which similarly begins with a step 76a of the user viewing the action item. That action item may also be viewed on the map 44 according to a step 76b. The user then navigates to a specific floor, then selects a public or pinned overlay in a step 76c. Optionally, additional pins may then be added to the selected public or pinned overlays per step 76d.

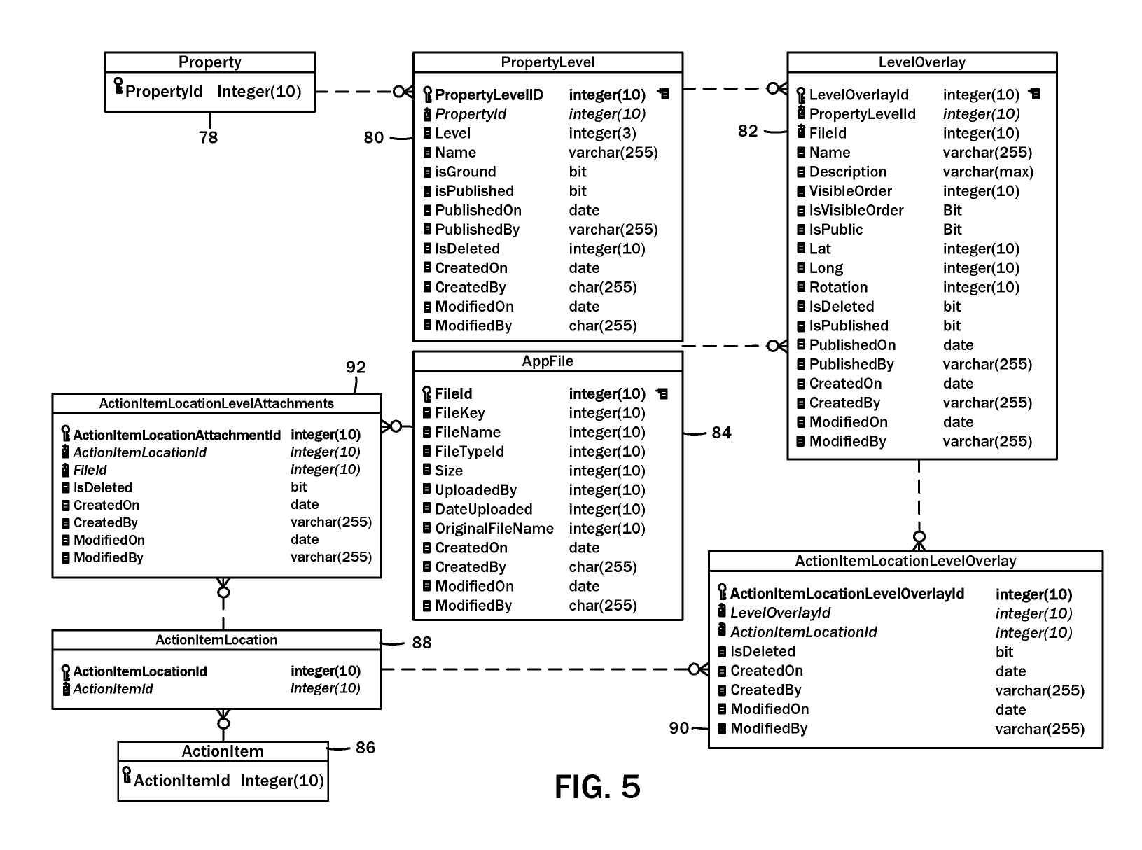

Referring to the diagram of FIG. 5, there is shown an exemplary implementation of a data structure of the database 18 to store the various level, overlay, and action item data utilized in various embodiments of the system 10. As indicated above, a given location is defined by one or more levels or floors, and to this end, a Property table 78 is comprised of a single field that identifies a specific property, and serves as a key field. A PropertyLevel table 80 references that property identifier and associates a given PropertyLevel record set thereto. Each PropertyLevel table 80 includes an identifier specific to the level, along with other fields such as the name, whether the level is the ground level, and whether it is published. Additionally, other administrative data such as publisher identity, publish date, deletion flag, creation date, creator identify, modification date, and modifier identity, are also included.

Multiple overlays may be associated within a given level, which is defined by a LevelOverlay table 82. Similar to the PropertyLevel table 80, the LevelOverlay table 82 is in turn linked to the PropertyLevel table 80 by the PropertyLevel identifier. The LevelOverlay table 82 includes field such as a file identifier, a name, a description, and various fields defining visibility of the overlay. The private or public status of the overlay is defined, along with the latitude and longitude coordinate values and rotation degree setting forth the positioning of the overlay on the map 44 is defined. There are various administrative data fields in the LevelOverlay table 82, including publisher identity, publish date, deletion flag, creation date, creator identify, modification date, and modifier identity.

A specific file may be associated with a given overlay, so there is an AppFile table 84 that is associated to the overlay with a FileId field. The AppFile table 84 includes a unique key identifier of the file, as well as a file name, a file type identifier, the size of the file, the uploader, the date of the upload, an original file name, the file creation date, the file creator/uploader, the file modification date, and the file modifier.

Each overlay may include action items. A table ActionItem 86 is a single field table with a unique identifier field for an action item. This value is referenced from other tables that further define the location, of the action item, attachments associated with the action item, and the overlay to which the action item is linked. In this regard, there is an ActionitemLocation table 88 that includes a field for the action item identifier, along with a field for the location of the action item. The location, in turn, is further defined in a ActionitemLocationLevelOverlay table 90 that is linked to the LevelOverlay table 82 via the level overlay identifier, and linked to the ActionitemLocation table 88 via the action item location identifier. The ActionitemLocationLevelOverlay table 90 further includes various administrative fields, e.g., the deletion flag, creation date, creator identify, modification date, and modifier identity.

A given action item may also include multiple attachments, so an ActionitemLocationLevelAttachments table 92 provides the link between an action item location identifier field of the ActionitemLocation table 88 and the AppFile table 84 via the FileId field. Similar to the other tables, the ActionitemLocationLevelAttachments table 92 includes administrative fields such as the deletion flag, creation date, creator identify, modification date, and modifier identity. Again, the foregoing structure and relationships of the various tables are presented by way of example only and not of limitation. Any other suitable database structure may be substituted without departing from the scope of the present disclosure.

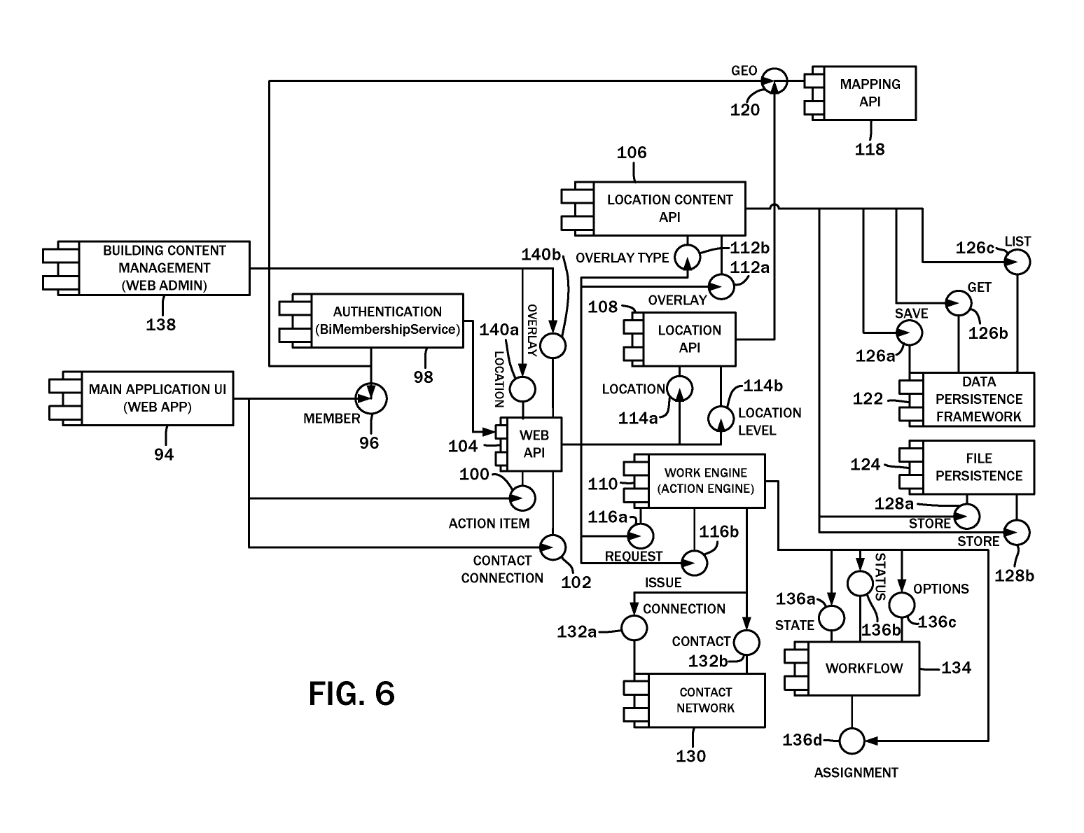

The system 10 may also be described in terms of the components and connections between the components. A Universal Modeling Language (UML) component diagram is shown in FIG. 6, and represents one possible implementation of the system 10. As shown, there is a main application user interface component 94, also referred to as the web app. Several interfaces with other components are contemplated, including a member interface 96 with an authentication component 98, along with an action item interface 100 and a contact connection interface 102, both to a web application programming interface (API) component 104, which is dependent on the authentication component 98.

The web API component 104 interfaces with several other components, including a location content API component 106, a location API component 108, and an action item engine component 110). In further detail, there is an overlay interface 112a and an overlay type interface 112b between the web API component 104 and the location content API component 106. Moreover, there is a location interface 114a and a location level interface 116 between the web API component 104 and the location content API component 106. Finally, there is a request interface 116a and an issue interface 116b between the web API component 104 and the action item engine component 110.

There is a mapping API 118, to which the location API component 108 connects over the geographic data interface 120. There is also a data persistence framework component 122 and a file persistence component 124 that are connected to the location content API component 106. There is a save interface 126a, a get interface 126b, and a list interface 126c between the location content API component 106 and the data persistence framework component 122, while there is a first store interface 128a and a second store interface 128b between the location content API component 106 and the file persistence component 124.

The action item engine component 110, in turn, is connected to a contact network component 130 via a connection interface 132a and a contact interface 132b. Along these lines, the action item 110 is also connected to a workflow component 134 via a state interface 136a, a status interface 136b, an options interface 136c, and an assignment interface 136d.

An administrative component is also contemplated, e.g., the building content management component 138, which is connected to the web API component 104 via an overlay interface 140a and a location interface 140b. Additionally, the building content management component 138 is connected to the mapping API 118 via the geographic data interface 120. The foregoing illustrates the inter-related components of the system 10, and the data that is exchanged from one component to another.

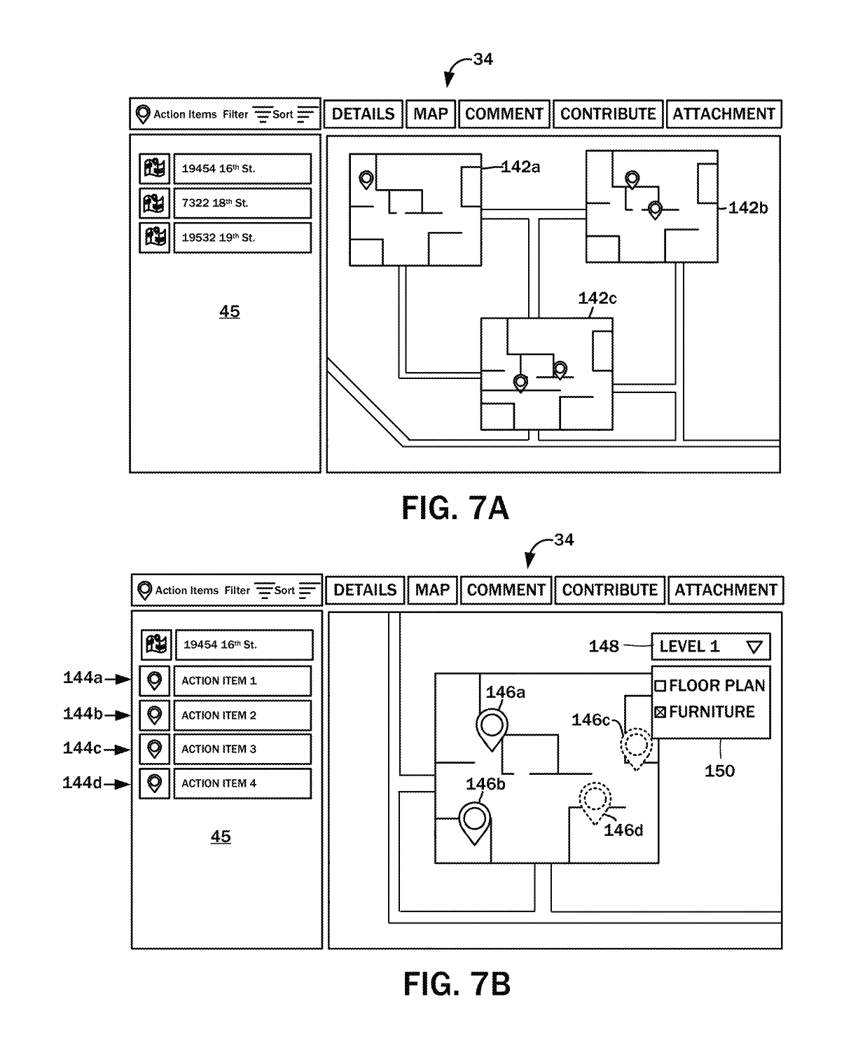

As described above with reference to FIG. 4B, the user interaction sequence of a regular account user 12b may begin with viewing a location per step 70a. The screen capture of FIG. 7A illustrates such a default view of the map 44, with default viewing plans selected from the left sidebar 45. There are three separate locations listed in the left sidebar 45, with each corresponding to a building plan 142a-142c.

Once one of the locations is selected in the action item sidebar, the graphical user interface 34 may transition to a view shown in FIG. 7B, with just the selected building plan 142c in view. The view of the map 44 is likewise adjusted with increased magnification. The left sidebar 45 lists the multiple action items 144a-144d, which correspond to the pins 146a-146d. The graphical user interface 34 further illustrates a level navigation element 148, which is understood to be a dropdown list, scrollable list, or other user interface element that shows each of the available levels of the map 44, with a specific one being selectable. Additionally, there is an overlay selection window 150, which can selectively activate one or more overlays. In the example shown, there is a floor plan overlay and a furniture plan overlay, and with only the furniture plan being selected, the pins 146c and 146d that are not associated or linked with the furniture plan may be subdued. Furthermore, because the first pin 146a and the second pin 146b are understood to be associated with action plans that are associated or linked with the furniture plan, they may be rendered in solid. By default when just the location is selected, all of the overlays and pins associated therewith may be shown in the graphical user interface 34.

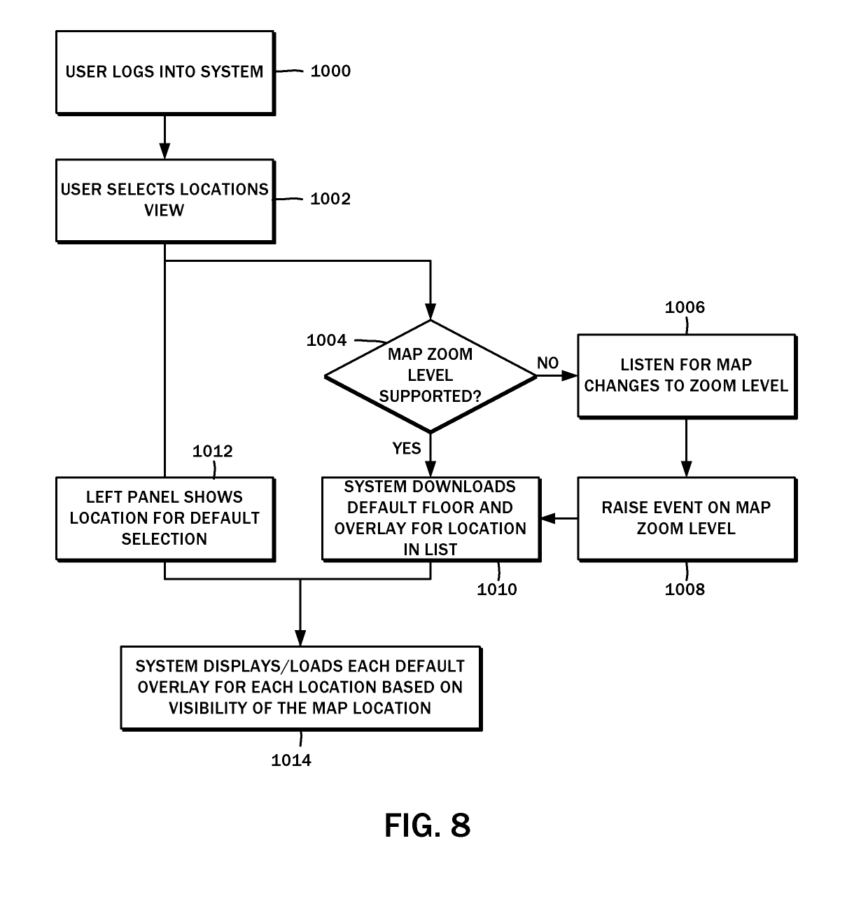

Referring now to the flowchart of FIG. 8, additional details of the procedure for displaying the default locations will be considered. There is a step 1000 of the user 12 logging into the system 10, following by the user selecting the locations view option in a step 1002. According to step 1004, the left panel, e.g., the left sidebar 45 is displayed, and populated with all of the locations being managed. Initially selected is the default location. At the same time, it is determined whether the selected map zoom level is supported in a decision step 1006; if not, the sequence proceeds to listening for map changes to the zoom level according to a step 1008, and once the zoom level change event is raised in response to user input in step 1010, the system 10 begins the download of the default floor and the overlay for the specified location per step 1012. If it is evaluated that the zoom level is, indeed, supported, the sequence proceeds to this step. Thereafter, in a step 1014, the system 10 loads each default overlay for each location based on visibility of the map location.

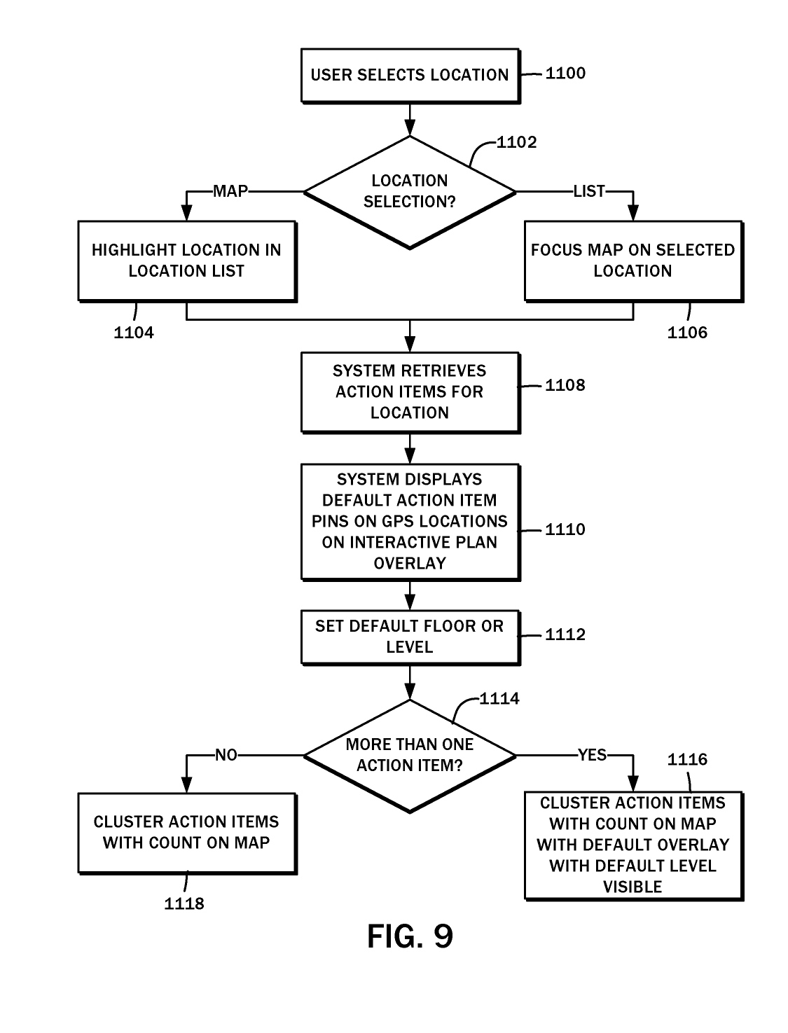

FIG. 9 is a flowchart of a sequence of steps taken once the user 12 provides a selection of a location within either the map or the list. There is a prerequisite step 1100 of the user selecting the location, a decision branch 1102 evaluates whether the selection was based on the map 44 or the action item listing 48. If the selection is made from the map 44, the sequence proceeds to a step 1104, in which the location in the location list/left sidebar 45 is highlighted. If the selection is made from the location list/left sidebar 45 instead, the map 44 is focused on the selected location per step 1106. In either case, the sequence then proceeds to a step 1108 of retrieving the action items for the selected location. Then, in a step 1110, there is a step of displaying the default action item pins at the designated locations on the plan overlay. A default floor is the set in step 1112, and within the area of view, it is determined whether there is more than one action item/pin in a decision branch 1114. If there are, then the sequence proceeds to a step 1116 in which the action items are clustered, and a count of the number of action items is shown on the default overlay and the default map level. If not, then the sequence proceeds to a step 1118 of clustering the action items with the count on the map 44.

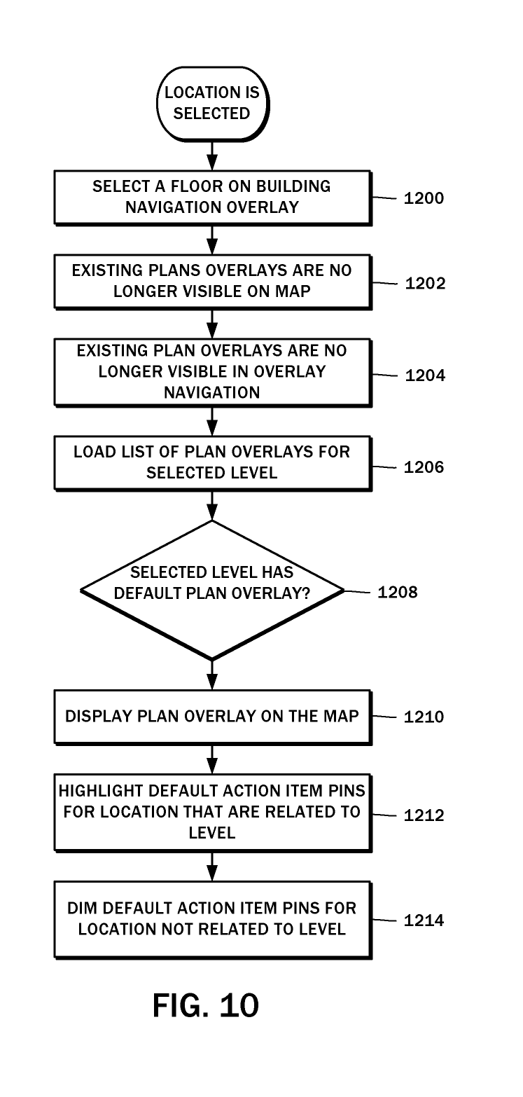

FIG. 10 is a flowchart illustrating the sequence of steps taken once the location is selected. There is a step 1200 of selecting a floor on a building navigation overlay. This is understood to correspond to the aforementioned step of selecting a level in the level navigation element 148. Then per step 1202 and 1204, existing plan overlays may no longer visible on either the map or the overlay navigation window. In a step 1206, the list of plan overlays for the selected level are loaded. To the extent there is a default overlay for that level as determined by a decision branch 1208, it is displayed initially according to a step 1210. Then, in a step 1212, the default action item pins can be highlighted for the selected location, and also which are related to the selected floor/level. Those default action items that are for the selected location, but are not related to the selected level, may be dimmed in a step 1214.

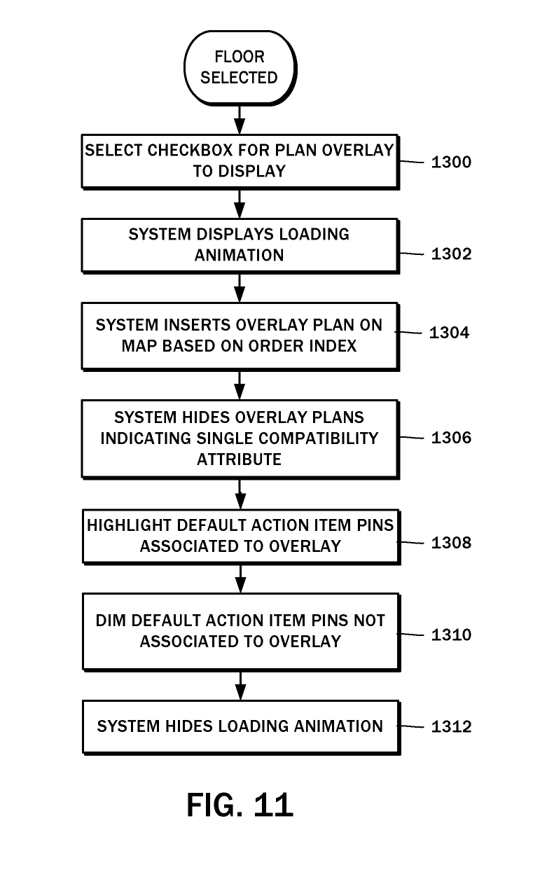

Referring now to the flowchart of FIG. 11, the sequence of steps in the user interaction following the selection of the floor/level of the facility will be considered. In a step 1300, a checkbox presented within the overlay selection window 150 may be selected. To the extent the retrieval of the plan overlay from the database 18 and/or the system 10 is not immediate, a loading animation may be shown in the graphical user interface 34 according to a step 1302. Then in a step 1304, the overlay plan is inserted on to the map 44 based on an order index. Some plan overlays are understood to be flagged as presentable only by itself, and accordingly a flag or attribute to that effect may be set. In a step 1306, those plan overlays with the single compatibility attribute being set are hidden. Additionally, in a step 1308, the default action item pins associated with the displayed plan overlays are highlighted. In a step 1310, those default action item pins not associated with the display plan overlays are dimmed. There may also be an optional step 1312 of hiding the loading animation upon completion of the foregoing steps.

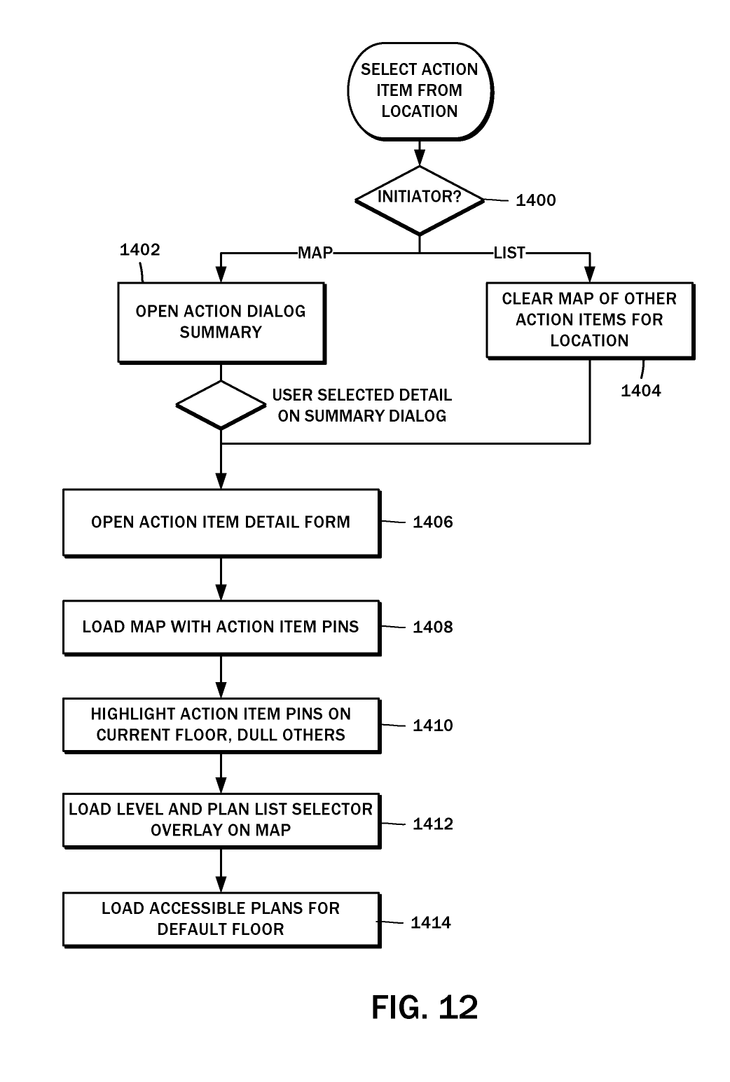

The flowchart of FIG. 12 illustrates the sequence of steps in the user interaction following the selection of an action item from a location. In a decision step 1400, it is determined whether that selection was made from the map 44 or a listing such as the one generated in the left sidebar 45. If the selection was made from the map 44, an action dialog summary is opened according to a step 1402. Otherwise, the map is cleared of other action items in a step 1404. Once the user invokes the functionality to retrieve additional detail, the sequence continues with opening an action item detail form in a step 1406. Then, the map can be loaded with the action item pins/markers according to a step 1408, followed by the highlighting of action item pins on the current floor in a step 1410. Other action item pins not on the current floor may be dulled. Following this step, the level/floor may be loaded, and the plan overlay selector is rendered on the primary workspace 42 per step 1412. The accessible plans for the default floor are also loaded in a step 1414.

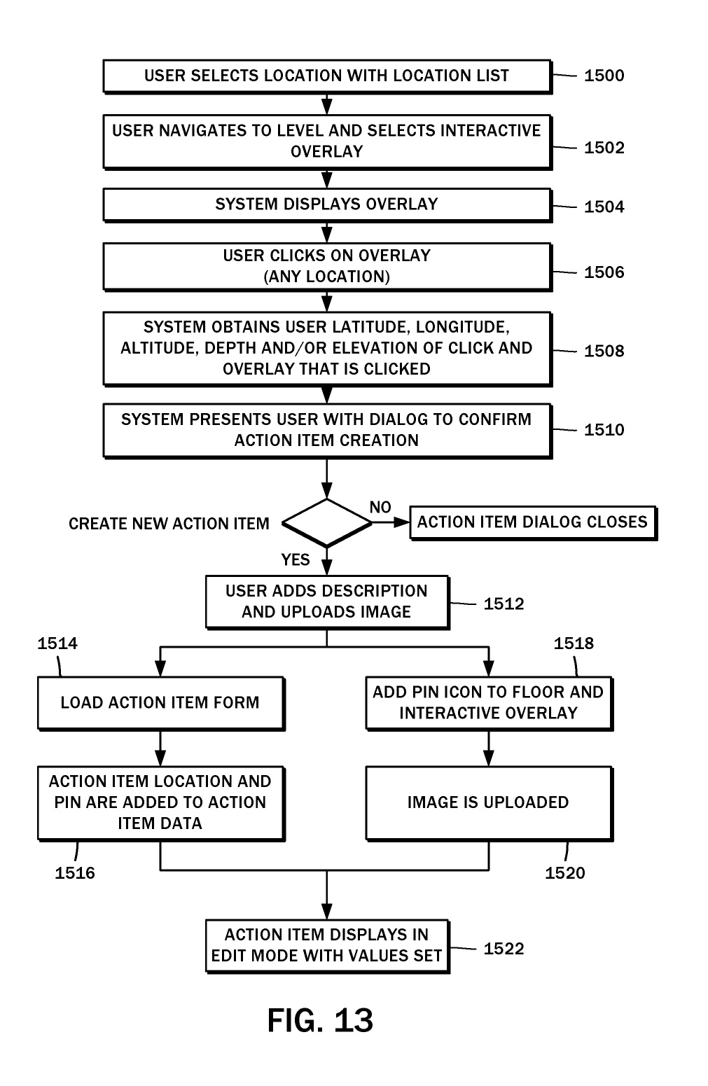

According to still another aspect of the present disclosure, as discussed above, the user can create action items on the system 10 as well. Referring to the flowchart of FIG. 13, the procedure begins with a step 1500 of selecting the location in which the action item is to be created. This selection is understood to be made from the location list. Once the map 44 is loaded, the user 12 navigates to the desired level and selects the desired plan overlay in accordance with a step 1502. The system 10 then displays the plan overlay in a step 1504, and the user specifies a location within the plan overlay in a step 1506. In accordance with step 1508, the latitude, longitude, altitude, depth, and/or elevation of the position of the input is obtained, and dialog confirming the action item creation is presented in a step 1510. To the extent there is no physical location involved, but is rather a virtual location or asset, a corresponding position data may be obtained. An action item form is then loaded according to a step 1512, followed by a step 1516 of adding the location of the action item and the action item itself to the database 18. Within the sequence, there may also be a step of adding the pin icon to the floor and the interactive overlay per step 1518, as well as uploading attached images per step 1520. Following the completion of these steps, the sequence may proceed to a step 1522 of displaying the action item in the action item dialog in edit mode, with the inputted values populating the form fields.

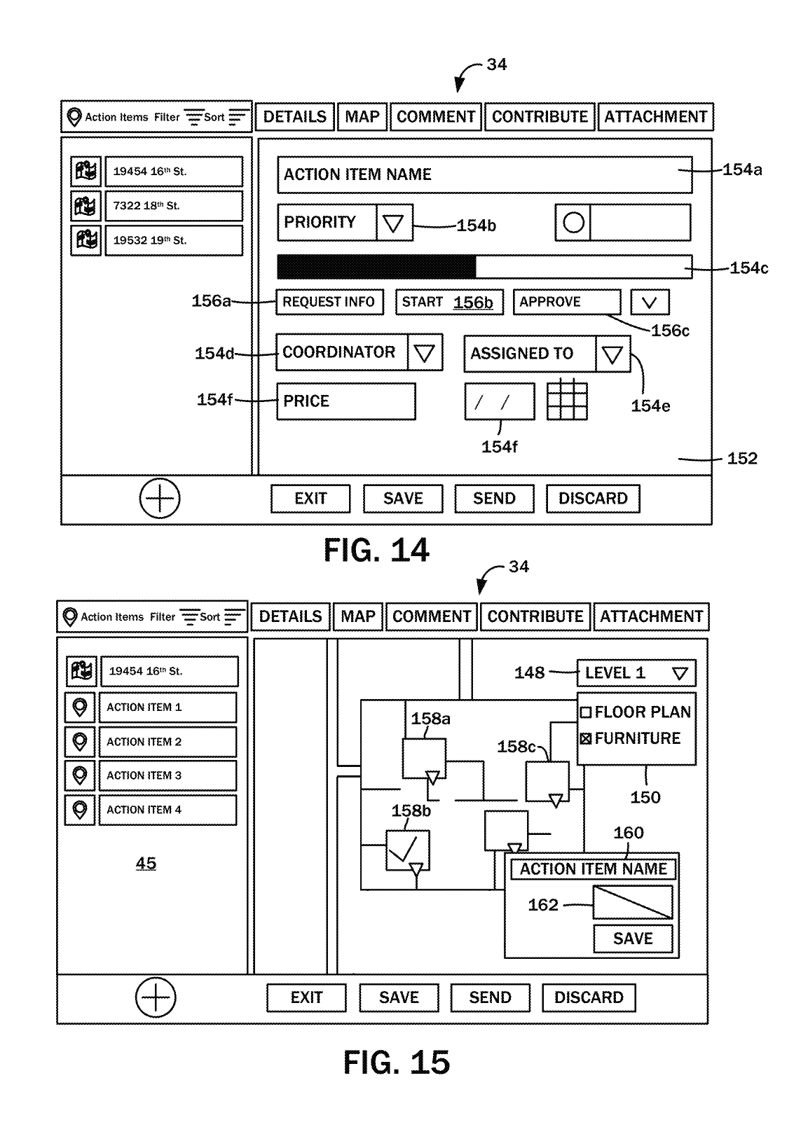

FIG. 14 is a screen capture of another embodiment of the graphical user interface 34 for the system 10, but with an action item entry form overlay 152. As shown, there is a first field 154a for entering the name of the action item. Additionally, a priority level may be set via a pull-down list 154b. A task progress indicator 154c shows the progress of the action item towards completion, and is understood to accept user input modifying the completion percentage. A coordinator for the task may be defined with another pull-down list 154d, and the user account to which the action item is assigned may be set with a pull-down list 154e. The quoted price of the services for the action item may be entered in a field 154f, while a date (either a start date or a due date) may be set in a field 154g. The specific fields illustrated in FIG. 14 are show as examples only, and any other pertinent information may be requested. Buttons corresponding to input commands are also included within the action item entry form overlay 152, including a information request button 156a, a start button 156b that indicates that work has begun on the action item, and an approve button 156c that may indicate to the other users that the work relating to the action item can be started.

FIG. 15 is a screen capture of an embodiment of the graphical user interface 34 for the system 10 illustrating multiple pins 158a-c corresponding to the action items. Additionally shown is a pin addition dialog window that is positioned in the vicinity of the newly added pin 158d. There may be a text input box 160 for entering the name and other information pertaining to an action item as discussed above. There may also be a file upload hotspot 162 to which a file icon may be dragged from within the operating system, and the corresponding file can be uploaded to the system 10. From the interface shown, it is also possible for the user to check and uncheck a pin, thereby marking the action item as complete or incomplete, respectively.

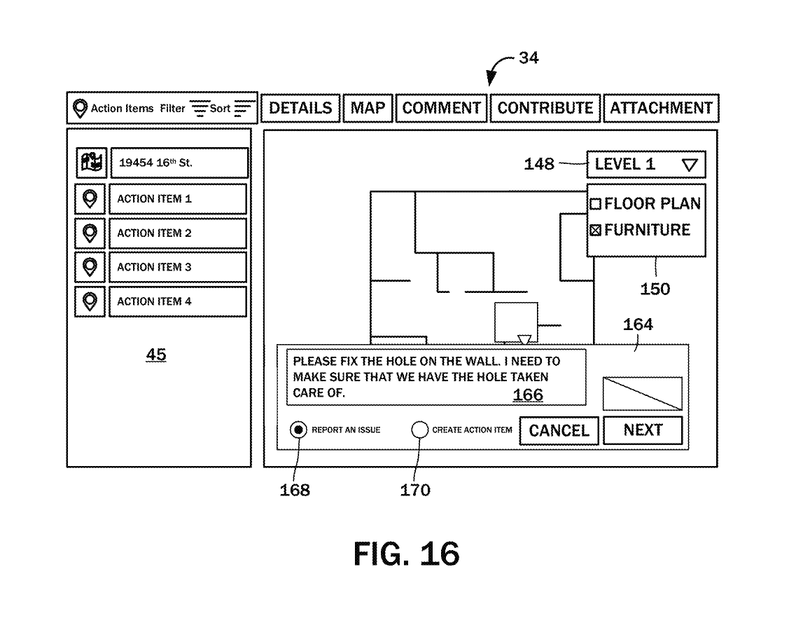

FIG. 16 is a screen capture of another embodiment of the graphical user interface 34, showing an exemplary issue reporting dialog 164. With this dialog, it is possible for users to enter comments regarding a specific location on the map. There is a text entry field 166 in which the comments may be entered, and there is a first radio button 168a that can be selected to create an issue report, and a second radio button 168b that can be selected to create an action item based on the comments. So that the user may also attach images and other files, the issue reporting dialog 164 includes the file upload hotspot 162.

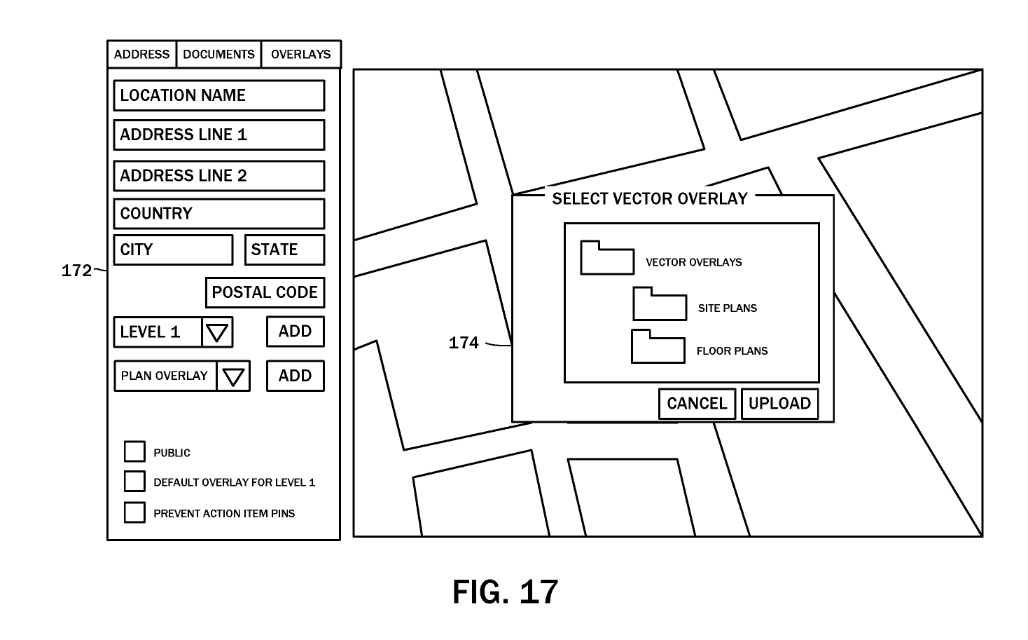

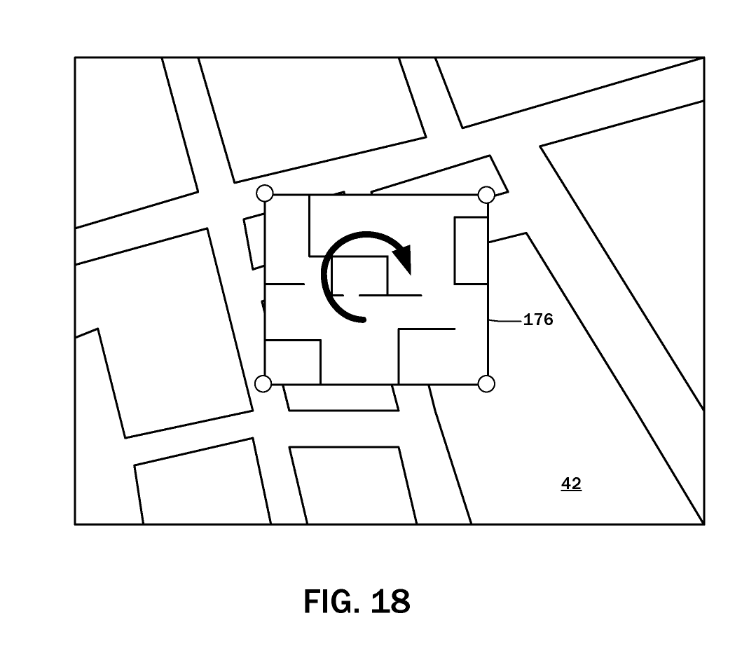

As discussed above with reference to the flowchart of FIG. 4A, the system 10 of the present disclosure also contemplates the system administrator 12a creating and modifying floors/levels as well as plan overlays. FIG. 17 depicts an exemplary embodiment of a graphical user interface 34 in which such modifications can be made. Upon logging in and loading the map 44, the address for the location, e.g., the place with which the uploaded overlay is to be associated, may be input into an address input sidebar 172. The map 44 may be refreshed to the inputted location, and a file upload dialog 174 may be generated. From this interface, the overlay file may be specified, then uploaded to the system 10. As best shown in FIG. 18, a graphical representation 176 of the overlay is then presented within the primary workspace 42. From here, the graphical representation may be enlarged, shrunk, and rotated with the adjustment controls thereon.

The particulars shown herein are by way of example and for purposes of illustrative discussion of the embodiments of the present disclosure only and are presented in the cause of providing what is believed to be the most useful and readily understood description of the principles and conceptual aspects of the interactive location plan overlay system. In this regard, no attempt is made to show more details than is necessary for a fundamental understanding of the disclosure, the description taken with the drawings making apparent to those skilled in the art how the several forms of the presently disclosed methods may be embodied in practice.

What is claimed is:

1. An interactive location plan overlay system, the system comprising:
a location interface to one or more maps for a location, each of the maps corresponding to a level and defined by a common coordinates grid;
an overlay interface to one or more location plan overlays each associated with a specific one the maps, the location plan overlays being defined by the common coordinates grid and pertaining to a category of the location;
a mapping user interface in communication with the location interface and the overlay interface to generate a display of a given one of the maps and the location plan overlays associated therewith in alignment with each other based upon the common coordinates grid;
an action item interface receptive to input of an action item associated with a specific location on a selected one of the location plan overlays of the corresponding one of the maps, the specific location of the action item being defined in accordance with the common coordinates grid; and
an action engine in communication with the action item interface, the received action item being stored and assignable by the action engine to a contact account for resolution.

2. The system of claim 1, further comprising:
an action item assignment interface in communication with the action engine maintaining a list of a plurality of contact accounts to which the received action item is assignable for resolution.

3. The system of claim 1, further comprising:
a business rules engine defining a workflow procedure associated with the action item.

4. The system of claim 1, wherein the mapping user interface generates a graphical marker element on the location plan overlays in correspondence to the specific location thereon to which the action item is associated.

5. The system of claim 1, wherein the mapping user interface displays the maps and the location plan overlays within a predefined area of a screen at a selected zoom level.

6. The system of claim 1, wherein the category is a structural plan of a building constructed at the location.

7. The system of claim 1, wherein the category is a floor plan of a building constructed at the location.

8. The system of claim 1, wherein the category is a landscape plan of the location.

9. A method for graphical collaboration of managing a location, the method comprising:
retrieving a map of the location from a location database by an interactive location plan overlay computer system, the map corresponding to a level and defined by a common coordinates grid;
retrieving, by an interactive location plan overlay computer system, a location plan overlay in response to a selection thereof, the location plan overlay being defined by the common coordinates grid, associated with the level, and pertaining to a category of the location;
transmitting to a first computer system for displaying on a first user interface for a first user, the map and the location plan overlay in alignment with each other based upon the common coordinates grid;
receiving, from the first user interface, an input of a specific location in the location plan overlay defined by a set of selection coordinates;
storing, by the interactive location plan overlay computer system, the set of selection coordinates in association with item data received from the first user interface as an action item; and
transmitting to the first computer system for displaying, on the first user interface, a graphical representation of the stored action item at the location within the location plan overlay and the map as defined by the set of selection coordinates.

10. The method of claim 9, wherein the selection of the location plan overlay is received from a user input.

11. The method of claim 9, wherein a default location plan overlay is selected without user intervention for display.

12. The method of claim 9, wherein the item data includes a text description for the action item.

13. The method of claim 9, wherein the item data includes a photograph for the action item.

14. The method of claim 9, further comprising:
transmitting to a second computer system for displaying on a second user interface for a second user, the map and the location plan in alignment with each other based upon the common coordinates grid, and the graphical representation of the action item at the location defined by the second of selection coordinates associated therewith.

15. The method of claim 14, further comprising:
receiving, from the second user interface, an input of a selection of the action item; and
displaying the item data on the second user interface.

16. The method of claim 14, further comprising:
receiving, from the first user interface, item assignee data from the first user.

17. The method of claim 16, wherein the second user is assigned the action item, the item assignee data thereof referencing a user account associated with the second user.

18. The method of claim 17, further comprising:
receiving an action item deletion command from the second user from the second user interface; and
setting a deletion flag of the action item in response to the action item deletion command.

19. A method for graphical collaboration of managing a location, the method comprising:
transmitting a request for a map of the location to an interactive location plan overlay computer system, the map corresponding to a level and defined by a common coordinates grid;
receiving a selection of a location plan overlay from a user interface;
transmitting a request for the selected location plan overlay to the interactive location plan overlay computer system, the location plan overlay being defined by the common coordinates grid, associated with the level, and pertaining to a category of the location;
receiving the map and the selected location plan overlay from the location plan overlay computer system;
displaying, on a user interface, the received map and the location plan overlay in alignment with each other based upon the common coordinates grid;
receiving, from the user interface, an input of a specific location in the location plan overlay defined by a set of selection coordinates;
transmitting, to the interactive location plan overlay computer system, the set of selection coordinates in association with item data received from the user interface as an action item;
displaying, on the user interface, a graphical representation of the action item at the location within the location plan overlay and the map as defined by the set of selection coordinates.

20. The method of claim 19, wherein the item data includes a text description for the action item.

21. The method of claim 19, wherein the item data includes a photograph for the action item.

22. The method of claim 19, wherein the user interface is rendered within a web browser application being executed on a client computer system.

23. The method of claim 19, wherein the user interface is rendered within a native application being executed on a client computer system.
